(19) United States
(12) Patent Application Publication
(10) Pub. No.: US 2015/0234573 A1
(43) Pub. Date: Aug. 20, 2015

(54) METHODS AND APPARATUS FOR ORGANIZING APPLICATIONS AND WIDGETS ON A MOBILE DEVICE INTERFACE

(71) Applicant: SPB SOFTWARE INC., Hackensack, NJ (US)

(72) Inventors: Vasily FILIPPOV, Saint-Petersburg (RU); Yaroslav GONCHAROV, Sosnovy Bor (RU)

(21) Appl. No.: 14/474,880

(22) Filed: Sep. 2, 2014

Related U.S. Application Data
(63) Continuation of application No. 12/896,117, filed on Oct. 1, 2010, now abandoned.

(51) Int. Cl. G06F 3/0484; G06F 3/0481

(52) U.S. Cl. CPC G06F 3/04842; G06F 3/04817

(57) ABSTRACT

A system provides a framework that allows a user to arrange the available applications on a display of the communications device. The framework limits the user's arrangement to maintain consistent organization and ease of location of the available applications for the user. The system represents each of the available applications with a respective image representation on the display. Each specific available application is restricted to a single instance of an image representation on the display. The system associates each of the image representations with a respective subset of image representations where the subsets of image representations are organized to assist the user to locate and interact with the image representations. The system provides at least one view, associated with each of the available applications, with which to render the image representation on the display.

### CROSS REFERENCE TO RELATED APPLICATIONS

This application relates to the following applications filed on the same date as the present application:

i) “METHODS AND APPARATUS FOR RENDERING A MOBILE DEVICE INTERFACE IN A CAROUSEL”, Filed Dec. 18, 2009, Attorney Docket Number SPB09-01

ii) “METHODS AND APPARATUS FOR ORGANIZING A COLLECTION OF WIDGETS ON A MOBILE DEVICE DISPLAY”, Filed Feb. 5, 2010, Attorney Docket Number SPB09-02

iii) “METHODS AND APPARATUS FOR RENDERING A COLLECTION OF WIDGETS ON A MOBILE DEVICE DISPLAY”, Filed Feb. 5, 2010, Attorney Docket Number SPB09-05

iv) “METHODS AND APPARATUS FOR ORGANIZING AND RENDERING A COLLECTION OF WIDGETS ON A MOBILE DEVICE DISPLAY”, Filed Feb. 10, 2010, Attorney Docket Number SPB09-10

v) “METHODS AND APPARATUS FOR RENDERING APPLICATIONS AND WIDGETS ON A MOBILE DEVICE INTERFACE IN A THREE-DIMENSIONAL SPACE”, Filed Oct. 1, 2010, Attorney Docket Number SPB10-04

The teachings and disclosure of the above co-filed applications are each incorporated by reference herein in their entirety.

### BACKGROUND

Smart phones are mobile phones with PC like features, including an operating system, software applications, a miniature QWERTY keyboard, touch screen, etc. Smart phones run various software applications, such as email clients, and provide Internet access. Given the size of the touch screen, only a subset of the available application can be rendered on the touch screen at any given time. Users advance through additional available software applications by sliding their finger along the touch screen, and/or tapping the touch screen. This movement modifies which subset of applications is displayed on the screen, sliding some of the displayed available applications off the touch screen and displaying other available applications. Smart phone users access various software applications via the touch screen (i.e., tapping the touch screen invokes the selected software application). In other words, users slide their finger along the screen to view the available software applications. Icons displayed on the touch screen represent the available software applications. When the desired software application is rendered on the screen, the user taps the touch screen at the location of the icon to invoke that application.

### SUMMARY

Conventional computerized technologies for displaying available applications on a communications device, such as a smart phone, suffer from a variety of deficiencies. In particular, conventional technologies for displaying available applications are limited in that conventional technologies often provide a hierarchy of screens requiring a user to navigate through these screens to reach the application the user wishes to access. Users must remember where, in the hierarchy, applications are located to efficiently access those applications. For example, if an application is located in a folder, the user must either remember in which folder the application is located, or open then close (possibly) several folders until the user locates the folder containing the desired application. Conventional technologies don't allow the user to preview the contents of, or access the most important items in the folder without locating, then opening that folder. Failure on the user's part to organize the applications efficiently within the folders may create more confusion when trying to locate the folder containing the desired application. Because of this, the task of learning how to use the communications device, and efficiently using the communications device may present a barrier for some users.

Additionally, conventional technologies allow users to add different views of the same application to the display of the communications device. For example, a user may add the application, or a shortcut (to an application) on the display of the communications device. The user may add the shortcut on the display, or in a folder rendered on the display of the communications device. The user may also add a widget of the application on the display, or in a folder rendered on the display. Widgets themselves may have different skins that display more or less of the information provided by the widget. The ability to add different views of the same application contribute to the confusion the user may face when trying to locate a desired application. The user must determine which view of the application (i.e., the application itself, a shortcut to the application, a widget of the application, etc.) to locate, and then remember where that view of the application is located, thus multiplying the efforts on the user's part to locate a desired application.

Embodiments disclosed herein significantly overcome such deficiencies and provide a system that includes a computer system and/or software executing an application organizing process that provides a framework that allows a user to arrange the available applications on a display of the communications device. The set of available applications include widgets. Widgets may be standalone applications that may be hosted by a widget system (i.e., a software service available to users for running the widgets on a graphical user interface). A widget system may host several widgets on the same page/screen of the mobile device display. Widgets may be focused applications that are generally smaller in size, and less complex than typical software applications. Widgets often take up little real estate on a display when operating. Widgets may be written in a variety of different languages. The widgets are each hosted by a respective widget engine. The framework limits the user's arrangement of the applications on the display to maintain a consistent organization, and ease of location of the available applications for the user. The application organizing process represents each of the available applications with a respective image representation on the display, and each specific available application is restricted to a single instance of an image representation on the display. The application organizing process provides at least one view, associated with each of the available applications, with which to render the image representation on the display. A view may be the application itself, a shortcut to the application, a widget of the application, etc. In other words, each application may be rendered on the display (or in a folder) with different views (i.e., as the application itself, a shortcut to the application, a widget of the application, etc.), but there can be only one instance of that application on the communications device. Additionally, the user may choose which view of the application is rendered on the display. While an application may be rendered with various views, the application organizing process limits each specific application to a single instance on the display. Thus, the user is not confused trying to remember where a particular view of an application is located.

The application organizing process associates each of the image representations with a respective subset of image representations. The subsets of image representations are the pages or screens that a user scrolls through while interacting with the display. The subsets of image representations are organized to assist the user to locate and interact with the image representations. The application organizing process allows the user to create a plurality of pages within a home screen where each of the plurality of pages is associated with a respective subset of image representations. The user is allowed to add image representations to each of the plurality of pages according to limitations imposed by the framework.

The application organizing process provides an option to render the available application as an image representation associated with a folder where the folder is rendered on the display. The application organizing process also provides a plurality of pre-defined views for the folder. Each of the pre-defined views determines how the folder is rendered on the display. The application organizing process allows the user to choose one of the plurality of pre-defined views to render the folder on the display. For example, a folder may be rendered on the display showing a preview of the contents of the folder. The preview may contain thumbnail images of some of the items contained within that folder. In an example embodiment, the user may access any of the applications associated with those thumbnail images by selecting the folder to open the folder on the display. The application organizing process then renders the opened folder on the display containing those image representations associated with the folder. The user may select image representations to access applications represented by the image representations.

A folder may also be rendered on the display with image representations of some of the applications rendered as contained within that folder. On the display, the user sees a graphic of a folder, and the image representations rendered within that graphic of the folder. Thus, the user is able to view some of the contents of the folder without opening the folder. Additionally, the user may access those applications by selecting the image representation on the display (i.e., those image representations that are rendered within the graphic of the folder on the display). This saves the user the step of opening the folder to directly access the application. The application organizing process allows the user to determine which image representations are rendered on the display along with the folder. In other words, the user can decide which applications are most frequently accessed and arrange the respective image representations (of those applications) such that they are rendered within the graphic of the folder on the display. The application organizing process allows the user to enter into a folder edit mode. The user then drags and drops image representations on the display to arrange the image representations in the order of the user's choosing. Once the user has completed arranging the order of the image representations, the application organizing process renders the folder containing those image representations according to the user's arrangement. In an example embodiment, the pre-defined view of the folder determines how many of the image representations may be rendered on the display along with the folder.

In an example embodiment, the application organizing process identifies a folder as a restricted type folder. In an example embodiment, a restricted type folder may be associated with a particular type of application or a particular type of object. Only image representations representing an application identified as a particular type of application (or object) may be associated with that particular restricted type folder. In another example embodiment, a restricted folder may also be restricted to contain only shortcuts to a particular type of object, such as images, Internet bookmarks, files, etc. When the user is organizing applications within pages of the home screen of the communications device, only image representations representing applications of the same restricted type (as the restricted folder) may be added to that folder. In an example embodiment, users may remove an image representation (representing an application of a restricted type) from the restricted folder, and place that image representation directly on the display. However, a user may not remove an image representation (representing an application of a restricted type) from the restricted folder, and place it into a different restricted folder associated with a different application type.

In an example embodiment, the application organizing process identifies a folder as a generic type folder where an image representation representing an application identified as a generic type application may be associated with one of a plurality of generic type folders. In other words, an image representation (representing a generic type application) may be placed in any other generic type folder. The user may add and remove image representations (representing generic type applications) freely. However, image representations (representing restricted type applications) may not be placed into generic type folders.

Other embodiments disclosed herein include any type of computerized device, workstation, handheld or laptop computer, or the like configured with software and/or circuitry (e.g., a processor) to process any or all of the method operations disclosed herein. In other words, a computerized device such as a computer or a data communications device or any type of processor that is programmed or configured to operate as explained herein is considered an embodiment disclosed herein.

Other embodiments disclosed herein include software programs to perform the steps and operations summarized above and disclosed in detail below. One such embodiment comprises a computer program product that has a computer-readable medium including computer program logic encoded thereon that, when performed in a computerized device having a coupling of a memory and a processor, programs the processor to perform the operations disclosed herein. Such arrangements are typically provided as software, code and/or other data (e.g., data structures) arranged or encoded on a computer readable medium such as an optical medium (e.g., CD-ROM), floppy or hard disk or other a medium such as firmware or microcode in one or more ROM or RAM or PROM chips or as an Application Specific Integrated Circuit (ASIC). The software or firmware or other such configurations can be installed onto a computerized device to cause the computerized device to perform the techniques explained as embodiments disclosed herein.

It is to be understood that the system disclosed herein may be embodied strictly as a software program, as software and hardware, or as hardware alone. The embodiments disclosed herein, may be employed in data communications devices and other computerized devices and software systems for such devices such as those manufactured by SPB Software, Inc. of Carson City, Nev., USA.

### BRIEF DESCRIPTION OF THE DRAWINGS

The foregoing will be apparent from the following description of particular embodiments disclosed herein, as illustrated in the accompanying drawings in which like reference characters refer to the same parts throughout the different views. The drawings are not necessarily to scale, emphasis instead being placed upon illustrating the principles disclosed herein.

FIG. 1 shows a high-level block diagram of a computer system according to one embodiment disclosed herein.

FIG. 2 shows an example three dimensional screen shot of a page containing image representations and a folder containing a preview of the image representations contained within that folder on the display of a communications device.

FIG. 3 shows an example three dimensional screen shot of a page containing image representations and a folder displaying some of the image representations contained within that folder along with a preview of additional image representations on the display of a communications device.

FIG. 4 shows an example three dimensional screen shot of an opened folder containing shortcuts to Internet bookmarks on the display of a communications device.

FIG. 5 shows an example three dimensional screen shot of a page containing image representations and a folder rendered with two rows of image representations on the display of a communications device.

FIG. 6 shows an example three dimensional screen shot of a page containing image representations and a folder in edit mode on the display of a communications device.

FIG. 7 shows an example three dimensional screen shot of a page containing image representations including a shortcut to a music application on the display of a communications device.

FIG. 8 shows an example three dimensional screen shot of a page containing image representations including a widget associated with a music application on the display of a communications device.

FIG. 9 shows an example three dimensional screen shot of a page containing image representations including a widget associated with a music application in edit mode on the display of a communications device.

FIG. 10 shows an example three dimensional screen shot of a page containing image representations and a generic type folder on the display of a communications device.

FIG. 11 shows an example three dimensional screen shot of a page containing both a restricted type folder and a generic type folder on the display of a communications device.

FIG. 12 shows an example three dimensional screen shot of a page containing image representations and a restricted type folder containing shortcuts to objects on the display of a communications device.

FIG. 13 shows an example three dimensional screen shot of an opened restricted folder on the display of a communications device.

FIG. 14 shows an example three dimensional screen shot of a page containing image representations and a restricted folder containing shortcuts to music objects on the display of a communications device.

FIG. 15 shows an example three dimensional screen shot of an opened restricted folder containing shortcuts to music objects on the display of a communications device.

FIG. 16 illustrates a flowchart of a procedure performed by the system of FIG. 1, when the application organizing process provides a framework that allows a user to arrange the available applications on a display of the communications device, according to one embodiment disclosed herein.

FIG. 17 illustrates a flowchart of a procedure performed by the system of FIG. 1, when the application organizing process represents each of the available applications with a respective image representation on the display, according to one embodiment disclosed herein.

FIG. 18 illustrates a flowchart of a procedure performed by the system of FIG. 1, when the application organizing process provides an option to render the available application as an image representation associated with a folder, according to one embodiment disclosed herein.

FIG. 19 illustrates a flowchart of a procedure performed by the system of FIG. 1, when the application organizing process renders the folder on the display with a subset of a plurality of image representations associated with the folder, according to one embodiment disclosed herein.

FIG. 20 illustrates a flowchart of a procedure performed by the system of FIG. 1, when the application organizing process provides an option to render the available application as an image representation associated with a folder and provides a preview, according to one embodiment disclosed herein.

FIG. 21 illustrates a flowchart of a procedure performed by the system of FIG. 1, when the application organizing process provides an option to render the available application as an image representation associated with a folder, and identifies the folder as a restricted or generic type folder, according to one embodiment disclosed herein.

FIG. 22 illustrates a flowchart of a procedure performed by the system of FIG. 1, when the application organizing process associates each of the image representations with a respective subset of image representations, according to one embodiment disclosed herein.

FIG. 23 illustrates a flowchart of a procedure performed by the system of FIG. 1, when the application organizing process provides at least one view, associated with each of the available applications, with which to render the image representation on the display, according to one embodiment disclosed herein.

FIG. 24 illustrates a flowchart of a procedure performed by the system of FIG. 1, when the application organizing process represents each of the available applications with a respective image representation on the display, according to one embodiment disclosed herein.

### DETAILED DESCRIPTION

Embodiments disclosed herein include a computer system executing an application organizing process that provides a framework that allows a user to arrange the available applications on a display of the communications device. The set of available applications include widgets. Widgets may be standalone applications that may be hosted by a widget system (i.e., a software service available to users for running the widgets on a graphical user interface). A widget system may host several widgets on the same page/screen of the mobile device display. Widgets may be focused applications that are generally smaller in size, and less complex than typical software applications. Widgets often take up little real estate on a display when operating. Widgets may be written in a variety of different languages. The widgets are each hosted by a respective widget engine. The framework limits the user's arrangement of the applications on the display to maintain a consistent organization, and ease of location of the available applications for the user. The application organizing process represents each of the available applications with a respective image representation on the display, and each specific available application is restricted to a single instance of an image representation on the display. The application organizing process provides at least one view, associated with each of the available applications, with which to render the image representation on the display. A view may be the application itself, a shortcut to the application, a widget of the application, etc. In other words, each application may be rendered on the display (or in a folder) with different views (i.e., as the application itself, a shortcut to the application, a widget of the application, etc.), but there can be only one instance of that application on the communications device. Additionally, the user may choose which view of the application is rendered on the display. While an application may be rendered with various views, the application organizing process limits each specific application to a single instance on the display. Thus, the user is not confused trying to remember where a particular view of an application is located.

The application organizing process associates each of the image representations with a respective subset of image representations. The subsets of image representations are the pages or screens that a user scrolls through while interacting with the display. The subsets of image representations are organized to assist the user to locate and interact with the image representations. The application organizing process allows the user to create a plurality of pages within a home screen where each of the plurality of pages is associated with a respective subset of image representations. The user is allowed to add image representations to each of the plurality of pages according to limitations imposed by the framework.

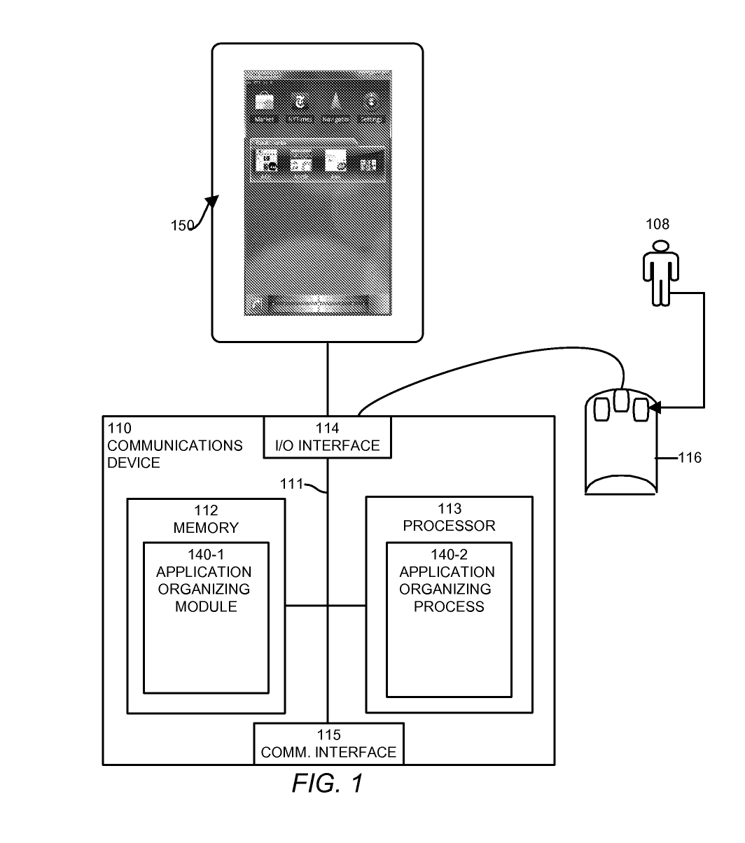

FIG. 1 is a block diagram illustrating example architecture of a communications device 110 that executes, runs, interprets, operates or otherwise performs an application organizing module 140-1 and application organizing process 140-2 suitable for use in explaining example configurations disclosed herein. The communications device 110 may be any type of computerized device such as a personal computer, workstation, portable computing device, console, laptop, network terminal or the like. An input device 116 (e.g., one or more user/developer controlled devices such as a keyboard, mouse, touch screen, etc.) couples to processor 113 through I/O interface 114, and enables a user 108 to provide input commands, and generally control a graphical user interface that the application organizing module 140-1 and process 140-2 provides on the display 150. As shown in this example, the communications device 110 includes an interconnection mechanism 111 such as a data bus or other circuitry that couples a memory system 112, a processor 113, an input/output interface 114, and a communications interface 115. The communications interface 115 enables the communications device 110 to communicate with other devices (i.e., other computers) on a network (not shown).

The memory system 112 is any type of computer readable medium, and in this example, is encoded with an application organizing module 140-1 as explained herein. The application organizing module 140-1 may be embodied as software code such as data and/or logic instructions (e.g., code stored in the memory or on another computer readable medium such as a removable disk) that supports processing functionality according to different embodiments described herein. During operation of the communications device 110, the processor 113 accesses the memory system 112 via the interconnect 111 in order to launch, run, execute, interpret or otherwise perform the logic instructions of an application organizing module 140-1. Execution of an application organizing module 140-1 in this manner produces processing functionality in application organizing process 140-2. In other words, the application organizing process 140-2 represents one or more portions or runtime instances of an application organizing module 140-1 (or the entire an application organizing module 140-1) performing or executing within or upon the processor 113 in the communications device 110 at runtime.

It is noted that example configurations disclosed herein include the application organizing module 140-1 itself (i.e., in the form of un-executed or non-performing logic instructions and/or data). The application organizing module 140-1 may be stored on a computer readable medium (such as a floppy disk), hard disk, electronic, magnetic, optical, or other computer readable medium. An application organizing module 140-1 may also be stored in a memory system 112 such as in firmware, read only memory (ROM), or, as in this example, as executable code in, for example, Random Access Memory (RAM). In addition to these embodiments, it should also be noted that other embodiments herein include the execution of an application organizing module 140-1 in the processor 113 as the application organizing process 140-2. Those skilled in the art will understand that the communications device 110 may include other processes and/or software and hardware components, such as an operating system not shown in this example.

A display 150 need not be coupled directly to communications device 110. For example, the application organizing module 140-1 can be executed on a remotely accessible computerized device via the network interface 115. In this instance, the display 150 may be displayed locally to a user 108 of the remote computer, and execution of the processing herein may be client-server based.

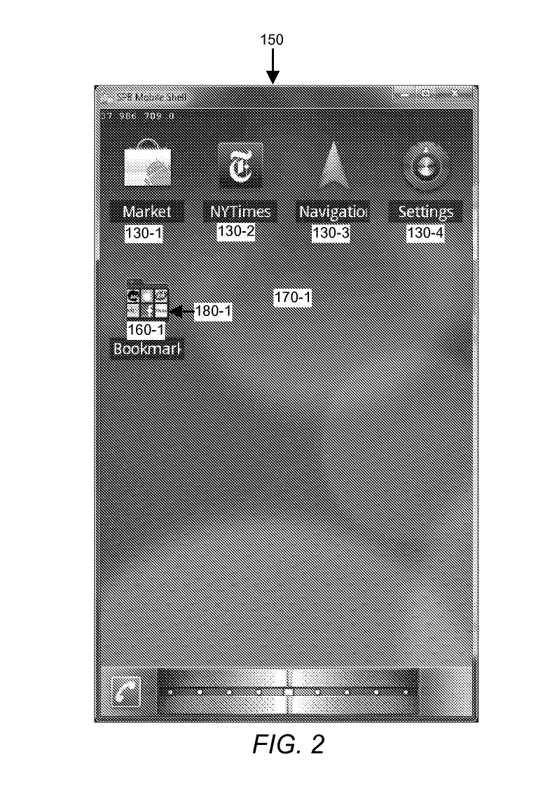

FIG. 2 shows an example three dimensional screen shot of a page (i.e., subset of image representations 130-1) containing image representations 130-1, 130-2, 130-3 and 130-4, and a folder 160-1 on the display 150 of a communications device 110. The folder 160-1 contains a preview of the contents, rendered as thumbnail images 180-1, contained within that folder 160-1. In an example embodiment, the user 108 may access the contents of the folder 160-1 by selecting the folder 160-1 on the display 150. In response, the application organizing process 140-2 renders the opened folder 160-1 on the display 150, and the user 108 may select the applications contained within the folder 160-1 by selecting image representations 130-N representing the desired applications.

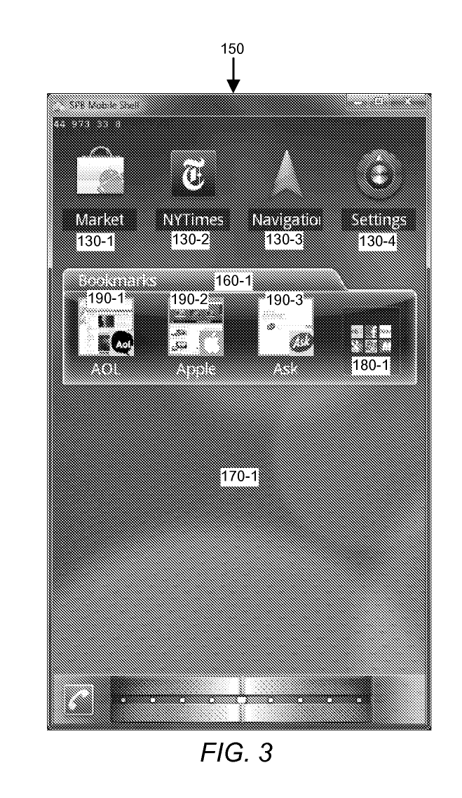

FIG. 3 shows an example three dimensional screen shot of a page (i.e., subset of image representations 130-1) containing image representations 130-1, 130-2, 130-3 and 130-4, and a restricted folder 160-1 on the display 150 of a communications device 110. In an example embodiment, a restricted folder 160-N (not shown) may be restricted to containing only image representations 130-N of a particular type of application. In another example embodiment, a restricted folder 160-1 (as shown here in FIG. 3) may be restricted to containing only shortcuts to a particular type of object. In this example, folder 160-1 is a restricted type folder 160-1 containing only shortcuts to Internet bookmarks objects 190-1, 190-2, and 190-3. The shortcuts to objects 190-1, 190-2, and 190-3 are rendered as image representations of those Internet bookmarks. The folder 160-1 also contains a preview of the remaining shortcuts to objects 190-N in the folder 160-1, rendered as thumbnail images 180-1, contained within that folder 160-1. In an example embodiment, the user 108 may access any of the shortcuts to objects 190-1, 190-2, and 190-3 directly by selecting them on the display 150 without having to open the folder 160-1. The user 108 may select any of the remaining shortcuts to objects 190-N by selecting the folder 160-1. The application organizing process 140-2 will then render the opened folder 160-1 (containing all the shortcuts to objects 190-N associated with folder 160-1) on the display 150, and the user 108 may select any of the remaining shortcuts to objects 190-N.

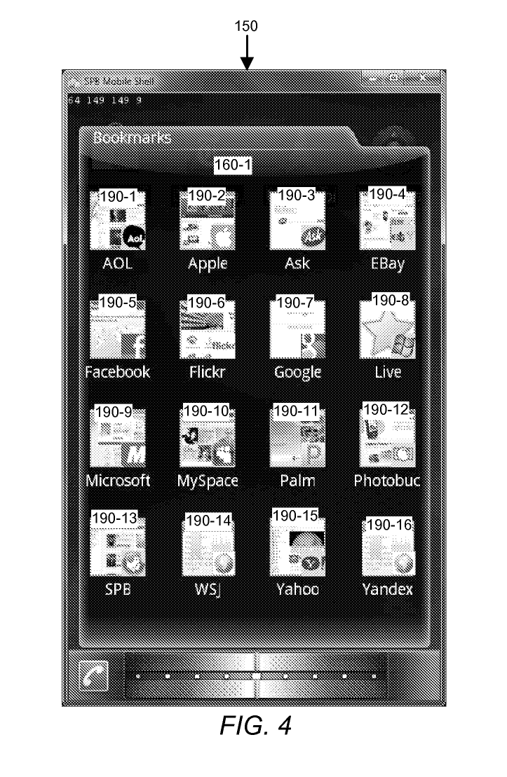

FIG. 4 shows an example three dimensional screen shot of an opened restricted folder 160-1 containing shortcuts to objects 190-1, 190-2, 190-3, 190-4, 190-5, 190-6, 190-7, 190-8, 190-9, 190-10, 190-11, 190-12, 190-13, 190-14, 190-15, and 190-16, on the display 150 of a communications device 110. The shortcuts are rendered as image representations of those shortcuts to objects 190-1 through 190-16. In this scenario, a user 108 selected a folder 160-1 on the display 150 (as described about in FIG. 3), and the application organizing process 140-2 rendered the open folder 160-1 on the display 150, rendering the contents of that folder 160-1. In an example embodiment, the application organizing process 140-2 renders all the shortcuts to objects 190-1 through 190-16 associated with the folder 160-1 on the display 150. However, if there are more shortcuts to objects 190-1 through 190-16 associated with the folder 160-1 than can fit on the display 150, the user 108 may drag a finger on the display 150 to scroll through (to view) the additional shortcuts to objects 190-N.

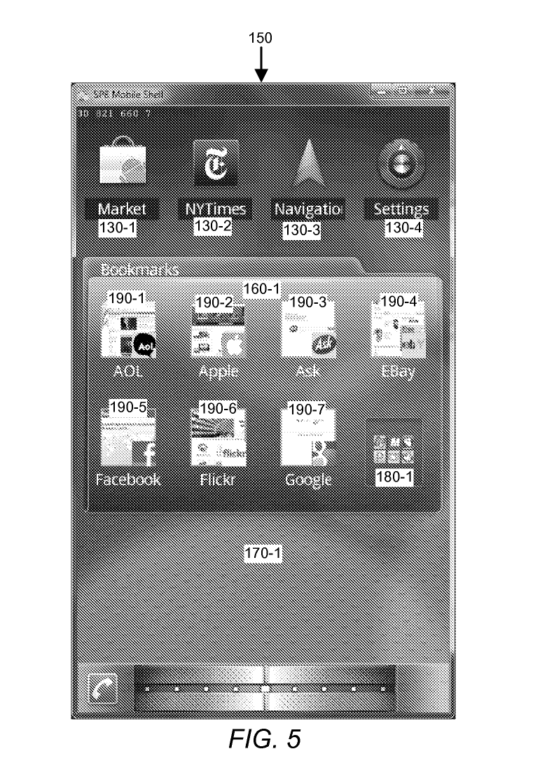

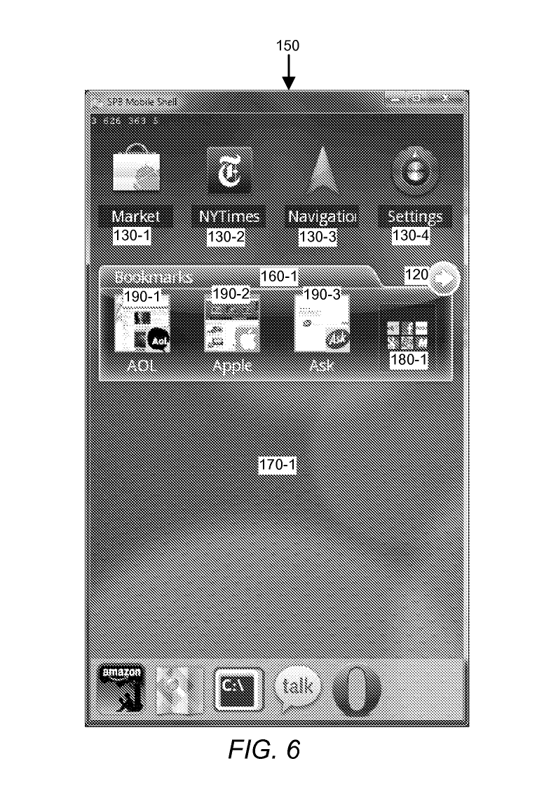

FIG. 5 shows an example three dimensional screen shot of a page (i.e., subset of image representations 130-1) containing image representations 130-1, 130-2, 130-3 and 130-4 and a restricted folder 160-1 containing shortcuts to Internet bookmarks on the display 150 of a communications device 110. The folder 160-1 is rendered in a view displaying two rows of shortcuts to objects 190-1, 190-2, 190-3, 190-4, 190-5, 190-6, and 190-7, and a preview of thumbnail images 180-1 of the remaining shortcuts to objects 190-N contained within the folder 160-1. In an example embodiment, a user 108 may change the view of the folder 160-1 to change the number of shortcuts to objects 190-N (for example, one row of shortcuts to objects 130-1, 130-2, 130-3 and 130-4 as shown in FIG. 6, or two rows of shortcuts to objects 190-1 through 190-7 as shown in FIG. 5) rendered on the display along with the folder 160-1. The user 108 may also directly access a particular Internet bookmark by selecting a respective shortcut to an object 190-2 directly on the display. For example, a user 108 may select a shortcut to an object 190-2 by touching the display 150 at the location of the shortcut to the object 190-2.

FIG. 6 shows an example three dimensional screen shot of a page (i.e. subset of image representations 130-1) containing image representations 130-1, 130-2, 130-3 and 130-4 and a folder 160-1 in edit mode on the display 150 of a communications device 110. The folder 160-1 is rendered in a view displaying one row of shortcuts to objects 190-1, 190-2, and 190-3, and a preview of thumbnail images 180-1 of the remaining shortcuts to objects 190-N contained within the folder 160-1. An arrow 120 indicates that the user 108 has entered into an edit mode to edit the view of the folder 160-1. In this edit mode, the user 108 may change the view of the folder 160-1, for example, from one row (depicted in FIG. 6), to two rows (depicted in FIG. 5), or a preview of the folder (depicted in FIG. 2 as the preview of shortcuts 180-1). In an example embodiment, the user 108 need only tap the arrow 120 once to add a widget. In other words, the user 108 may add multiple widgets by simply tapping the display 150 once for each widget added.

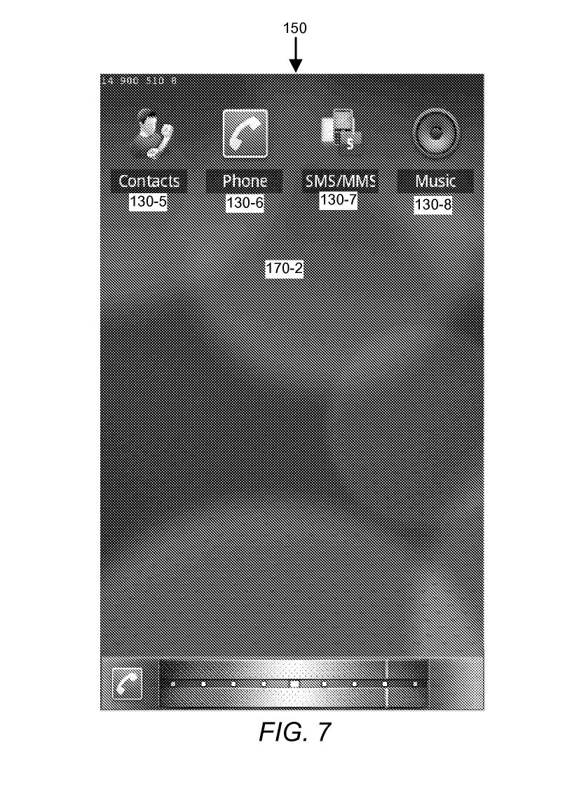

FIG. 7 shows an example three dimensional screen shot of a page (i.e., subset of image representations 130-2) containing image representations 130-5, 130-6, 130-7 and 130-8 on the display 150 of a communications device 110. Image representation 130-8 is a shortcut to a music application. The application organizing process 140-2 allows the user 108 to modify the view of the image representation 130-8.

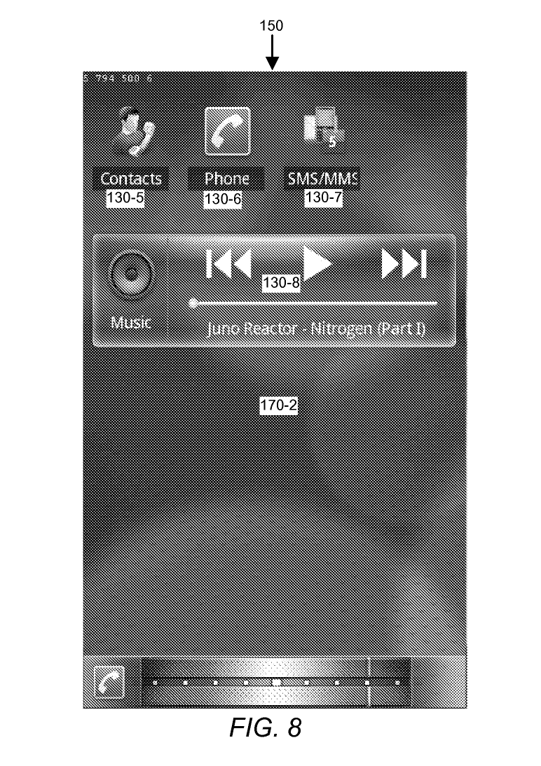

FIG. 8 shows an example three dimensional screen shot of a page (i.e., subset of image representations 130-2) containing image representations 130-5, 130-6, 130-7 and 130-8 on the display 150 of a communications device 110. Image representation 130-8 is shown as a music application widget.

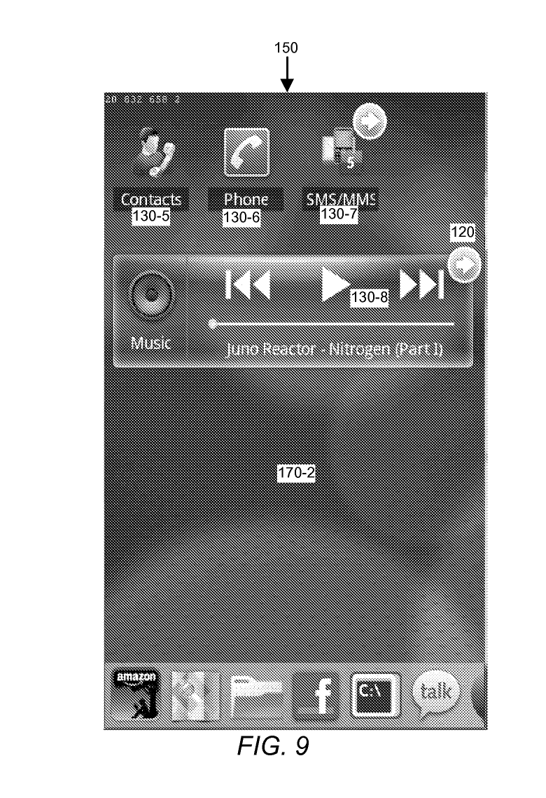

FIG. 9 shows an example three dimensional screen shot of a page (i.e., subset of image representations 130-2) containing image representations 130-5, 130-6, 130-7 and 130-8 on the display 150 of a communications device 110. Image representation 130-8 is shown as a music application widget. The application organizing process 140-2 allows the user 108 to modify the view of the image representation 130-8. The arrow 120 indicates that the user 108 has entered into an edit mode to edit the view of the image representation 130-8. In an example embodiment, the user 108 may change the view of the image representation 130-8 from a music application widget as shown here in FIG. 9 to, for example, a shortcut to a music application as shown in FIG. 7 (depicted as image representation 130-8 in FIG. 7). In an example embodiment, the user 108 simply taps the display 150 once to change, for example, the music application depicted in FIG. 7 (i.e., image representations 130-8) to the widget shown in FIG. 9 (also depicted as 130-8).

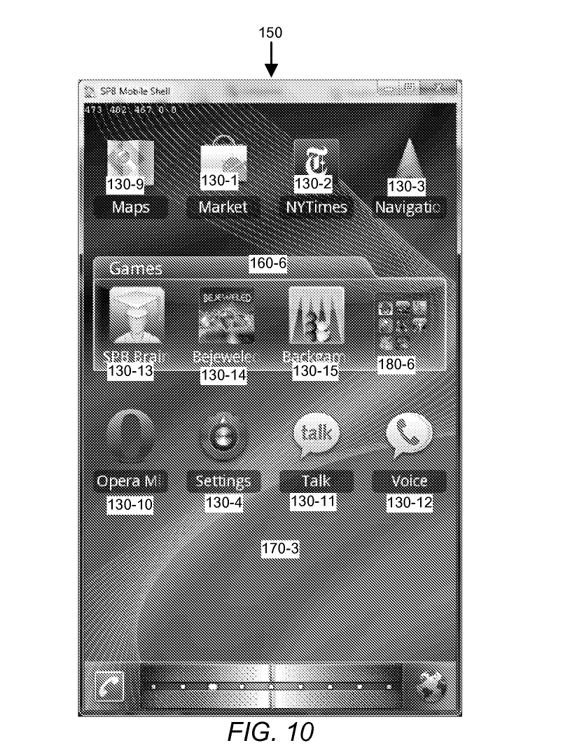

FIG. 10 shows an example three dimensional screen shot of a page (i.e., subset of image representations 130-3) containing image representations 130-9, 130-1, 130-2, 130-3, 130-10, 130-4, 130-11, and 130-12, and a generic type folder 160-6 on the display 150 of a communications device 110. The generic type folder 160-6 contains image representation 130-13, 130-14, 130-15 and 130-16, along with a preview of the remaining image representations 130-N shown as thumbnail images 180-6. In an example embodiment, a user 108 may remove image representations 130-N from a generic folder 160-6, and place those image representations 130-N into any other generic folder 160-N (not shown).

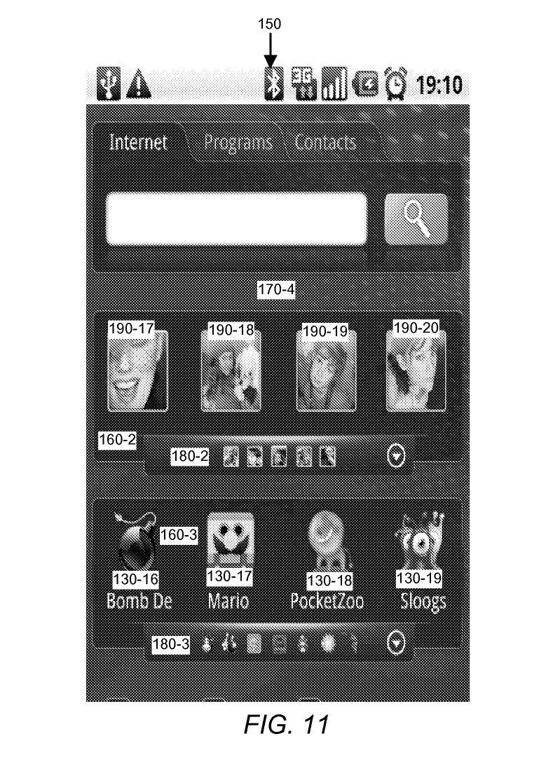

FIG. 11 shows an example three dimensional screen shot of a page (i.e., subset of image representations 130-4) containing both a restricted type folder 160-2 and a generic type folder 160-3 on the display 150 of a communications device 110. The restricted type folder 160-2 contains shortcuts to objects 190-17, 19-18, 190-19 and 190-20 (in this example, shortcuts to image objects) as well as a preview of thumbnail images 180-2. In FIG. 11, the preview of thumbnail images 180-2 is rendered linearly below the shortcuts to objects 190-17, 19-18, 190-19 and 190-20 whereas in FIG. 6, the preview of the thumbnail images 180-1 is rendered as a miniature folder, rendered alongside the shortcuts to objects 190-1, 190-2 and 190-3. The generic type folder 160-3 contains image representation 130-16, 130-17, 130-18 and 130-19. In an example embodiment, these image representations 130-16, 130-17, 130-18 and 130-19 may be removed from generic type folder 160-3, and added to any other generic type folder 160-N (not shown). The generic type folder 160-3 also contains a preview of thumbnail images 180-3 of the remaining image representations 130-N contained within folder 160-3.

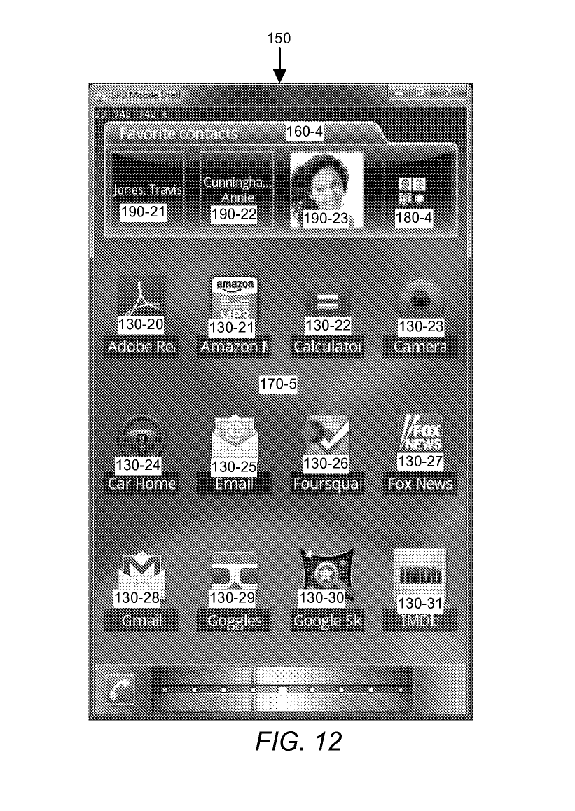

FIG. 12 shows an example three dimensional screen shot of a page (i.e., subset of image representations 130-5) containing image representations 130-20, 130-21, 130-22, 130-23, 130-24, 130-25, 130-26, 130-27, 130-28, 130-29, 130-30, 130-31, and a restricted type folder 160-4 on the display 150 of a communications device 110. The restricted type folder 160-4 contains shortcuts to objects 190-21, 190-22, and 190-23 (in this example, shortcuts to favorite contacts) as well as a preview of thumbnail images 180-4 of the remaining shortcuts to objects 190-N contained within the restricted type folder 160-4. The user 108 may select folder 160-4 to access the remaining shortcuts to objects 190-N. The user 108 may also select any of the shortcuts to objects 190-21, 190-22, and 190-23 directly to access those objects (i.e., without having to open the folder 160-4 to access those objects).

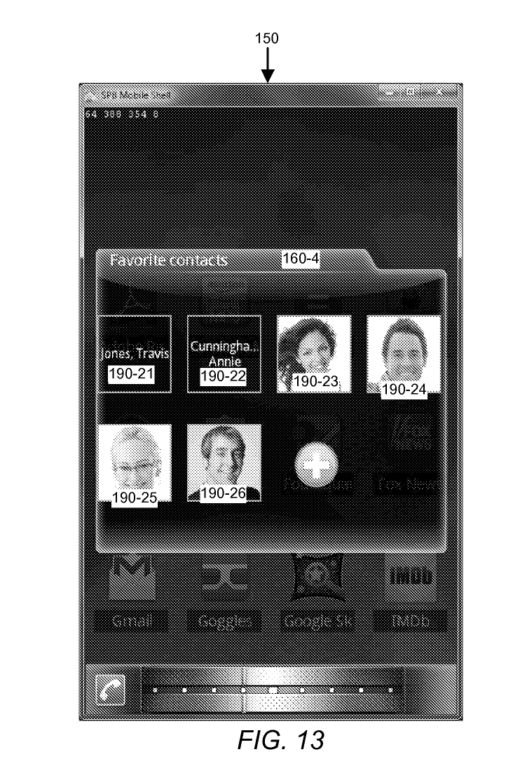

FIG. 13 shows an example three dimensional screen shot of an opened restricted type folder 160-4 on the display 150 of a communications device 110. The restricted type folder 160-4 contains shortcuts to objects 190-21, 190-22, 190-23, 190-24, 190-25 and 190-26 (in this example, shortcuts to favorite contacts). In an example embodiment, the user 108 may select any of the shortcuts to objects 190-21, 190-22, 190-23, 190-24, 190-25 and 190-26 to access that information directly.

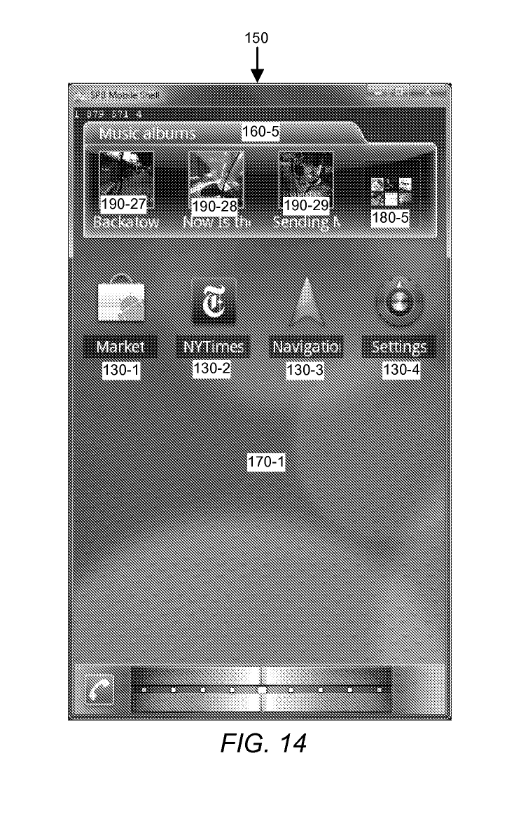

FIG. 14 shows an example three dimensional screen shot of a page (i.e., subset of image representations 130-1) containing image representations 130-1, 130-2, 130-3 and 130-4 and a restricted folder 160-5 on the display 150 of a communications device 110. The restricted type folder 160-5 contains shortcuts to objects 190-27, 190-28, and 190-29 (in this example, shortcuts to music objects) as well as a preview of thumbnail images 180-5 of the remaining shortcuts to objects 190-N contained within restricted type folder 160-5. The user 108 may select folder 160-5 to access the remaining shortcuts to objects 190-N. The user 108 may also select any of the shortcuts to objects 190-27, 190-28, and 190-29 directly to access those objects (i.e., without having to open the folder 160-5 to access those objects).

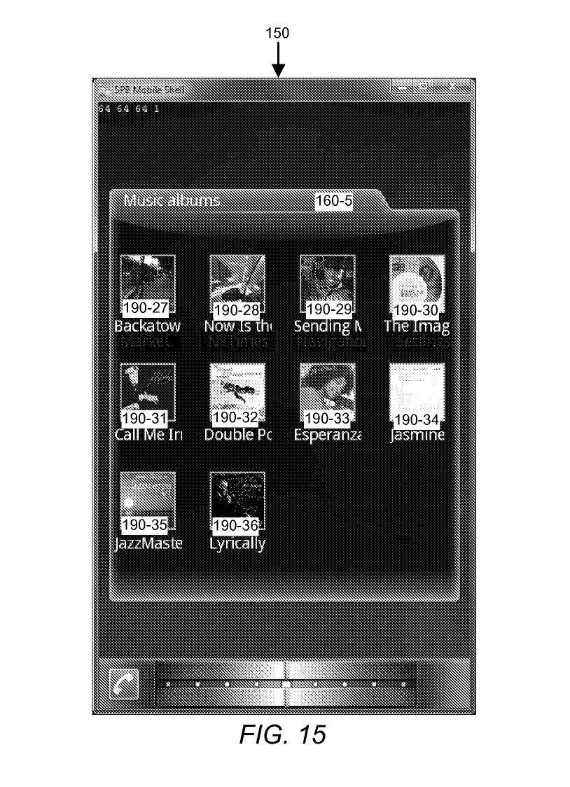

FIG. 15 shows an example three dimensional screen shot of an opened restricted folder 160-5 containing shortcuts to music objects 190-27, 190-28, 190-29, 190-30, 190-31, 190-32, 190-33, 190-34, 190-35, and 190-36 on the display 150 of a communications device 110. The restricted type folder 160-5 is the same folder 160-5 depicted in FIG. 14. Here, the user 108 has selected the folder 160-5 to view the contents. In response to the user's 108 selection of folder 160-5, the application organizing process 140-2 opens the folder 160-5 on the display 150 and renders the shortcuts to objects 190-27, 190-28, 190-29, 190-30, 190-31, 190-32, 190-33, 190-34, 190-35, and 190-36. The user 108 may select any of these shortcuts to objects 190-27 through 190-36 directly from the display 150.

Further details of configurations explained herein will now be provided with respect to a flow chart of processing steps that show the high level operations disclosed herein to perform the application organizing process 140-2.

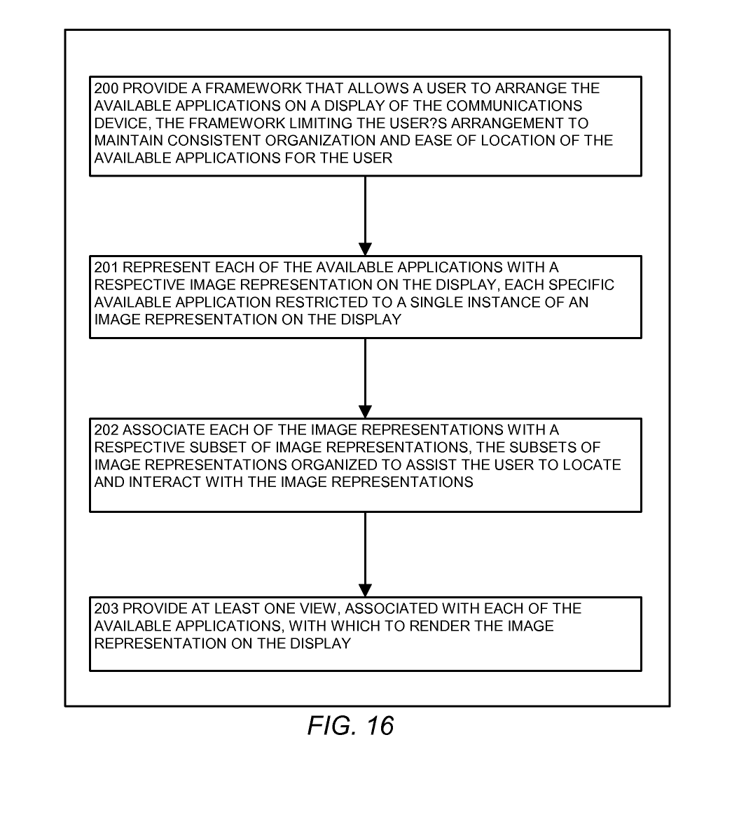

FIG. 16 is an embodiment of the steps performed by application organizing process 140-2 when it provides a framework that allows a user 108 to arrange the available applications on a display 150 of the communications device 110.

In step 200, the application organizing process 140-2 provides a framework that allows a user 108 to arrange the available applications on a display 150 of the communications device 110. The framework limits the user's 108 arrangement to maintain organization and ease of location of the available applications for the user 108. The limitations of the framework ensure that the arrangement and organization of the image representations 130-N representing the available applications facilitates the user's 108 interaction with the interface.

In step 201, the application organizing process 140-2 represents each of the available applications with a respective image representation 130-N on the display 150. The set of available applications include widgets. Widgets may be standalone applications that may be hosted by a widget system (i.e., a software service available to users for running the widgets on a graphical user interface). A widget system may host several widgets on the same page/screen of the mobile device display. Widgets may be focused applications that are generally smaller in size, and less complex than typical software applications. Widgets often take up little real estate on a display when operating. Widgets may be written in a variety of different languages. The widgets are each hosted by a respective widget engine. In an example embodiment, the image representation 130-N may be an icon that the user 108 selects to access the associated application. The image representation 130-N may also be, for example, a shortcut, widget, or folder containing a plurality of image representations 130-N. The application organizing process 140-2 restricts each specific application to a single instance of an image representation 130-N on the display 150. In other words, the user 108 may choose whether the application is rendered on the display 150 as an application, shortcut or widget, but only one instance of that application (rendered as the application itself, a shortcut to the application or a widget of the application) may be added to the display 150. Thus, the user 108 does not have to remember where the different views of each specific application are located within the communications device 110.

In step 202, the application organizing process 140-2 associates each of the image representations 130-N with a respective subset of image representations 130-N. The subsets of image representations 170-N are organized to assist a user 108 in locating and interacting with the image representations 130-N. Each subset of image representations 130-N is rendered as a page or screen on the communications device 110. A user 108 may scroll through each page (i.e., subset of image representations 130-N) by dragging a finger across the display 150. In an example embodiment, the user 108 may choose how the image representations 130-N and folders 160-N are arranged into subset of image representations 130-N.

In step 203, the application organizing process 140-2 provides at least one view, associated with each of the available applications, with which to render the image representation 130-N on the display 150. Examples of different views include a music application rendered as a image representation 130-8 shortcut in FIG. 7, and that same application rendered as a music application widget (also image representation 130-8) shown in FIG. 8.

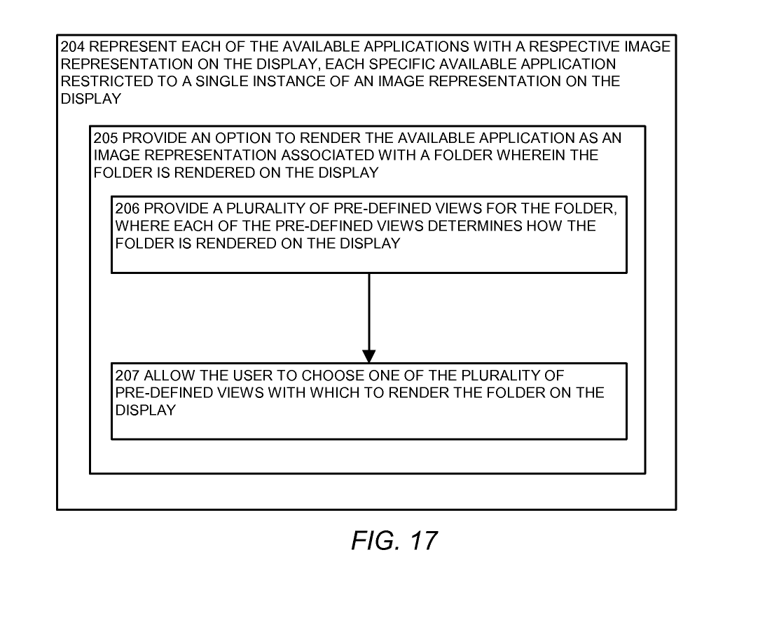

FIG. 17 is an embodiment of the steps performed by application organizing process 140-2 when it represents each of the available applications with a respective image representation 130-N on the display 150.

In step 204, the application organizing process 140-2 represents each of the available applications with a respective image representation 130-N on the display 150. Each specific available application is restricted to a single instance of an image representation 130-N on the display 150. In an example embodiment, the user 108 may arrange each image representation 130-N (representing a specific application) within a folder 160-N, or grouped on a page (i.e., subset of image representations 130-N). However, the application organizing process 140-2 limits each application to a single representation on the communications device 110. Thus, if a image representation 130-N (representing a specific application) is grouped within a folder 160-1, that image representation 130-N may not also be placed directly on the display 150. However, the user 108 may remove that image representation 130-N from the folder 160-1 and place it directly on the display 150.

In step 205, the application organizing process 140-2 provides an option to render the available application as an image representation 130-N associated with a folder 160-N where the folder 160-1 is rendered on the display 150. In an example embodiment, the user 108 may arrange and organize the image representations 130-N (representing specific applications) to facilitate the user's 108 location and interaction with those applications. The application organizing process 140-2 allows the user 108 to create folders 160-N and add image representations 130-N to those folders 160-N. For example, a user 108 might create a games folder 160-6 and add various game related applications to that folder 160-6. Thus the user 108 can easily locate game related applications by accessing that folder 160-6.

In step 206, the application organizing process 140-2 provides a plurality of pre-defined views for the folder 160-N. Each of the pre-defined views determines how the folder 160-N is rendered on the display 150. In an example embodiment, the application organizing process 140-2 may render the folder 160-N on the display 150 along with some of the image representation 130-N contained within that folder 160-N. The application organizing process 140-2 may, for example, render the folder 160-N with one row of image representations 130-N as depicted in FIG. 6 (i.e., folder 160-5), or two rows of image representations 130-N as depicted in FIG. 5 (also folder 160-5).

In step 207, the application organizing process 140-2 allows the user 108 to choose one of the plurality of pre-defined views with which to render the folder 160-N on the display 150. The application organizing process 140-2 provides a plurality of pre-defined views to allow the user 108 to choose the view that will provide the most convenience and effectiveness for the user's 108 interaction with the communications device 110. For example a pre-defined view of a folder 160-N containing two rows of image representations 130-N allows the user 108 to view (and directly access) more of the image representations 130-N contained within that folder 160-N. Conversely, a pre-defined view containing only one row of image representations 130-N takes up less real estate on the display 150, and allows the user 108 to arrange additional folders 160-N on that page (i.e., subset of image representations 130-N) of the display 150. The user 108 may change these views as is convenient for the user 108.

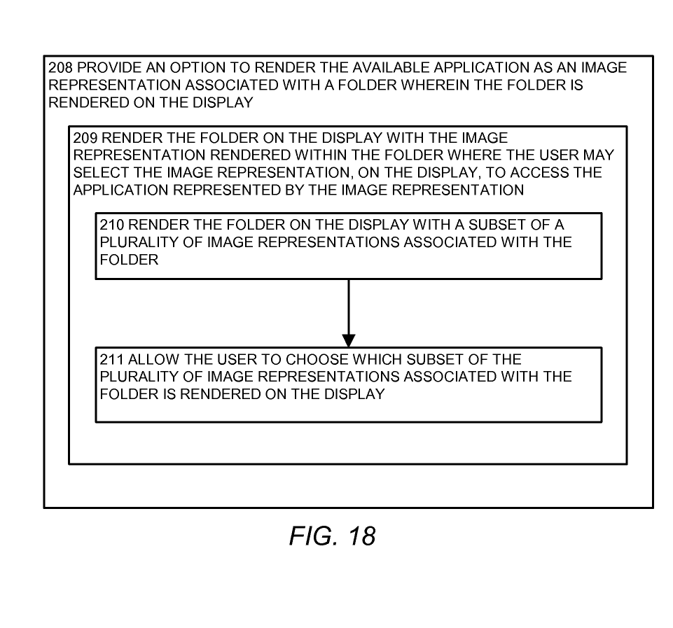

FIG. 18 is an embodiment of the steps performed by application organizing process 140-2 when it provides an option to render the available application as an image representation 130-N associated with a folder 160-N where the folder 160-N is rendered on the display 150.

In step 208, the application organizing process 140-2 provides an option to render the available application as an image representation 130-N associated with a folder 160-N where the folder 160-N is rendered on the display 150. The application organizing process 140-2 allows the user 108 to organize available applications (represented by image representations 130-N) into folders 160-N. The application organizing process 140-2 renders the folder 160-N on the display 150, and the user 108 may access the folder 160-N to view the contents of that folder 160-N (i.e., open the folder 160-N on the display 150).

In step 209, the application organizing process 140-2 renders the folder 160-N on the display 150 with the image representation 130-N rendered within the folder 160-N. On the display 150, the user sees a graphic of a folder 160-N, and the image representations 130-N rendered within that graphic of the folder 160-N. Thus, the user is able to view some of the contents of the folder 160-N without opening the folder 160-N. The user 108 may select the image representation 130-N, on the display 150, to access the application represented by the image representation 130-N. In an example embodiment, the application organizing process 140-2 renders the folder 160-N on the display 150 as a graphic of a folder 160-N. The application organizing process 140-2 also renders image representations 130-N (contained within that folder 160-N) within the graphic of the folder 160-N. FIG. 10 depicts an example folder 160-6 rendered with image representations 130-N 130-13, 130-14 and 130-15 rendered within the graphic of folder 160-6 on the display 150. The user 108 may access image representations 130-N 130-13, 130-14 and 130-15 directly by accessing them on the display. In other words, the user 108 does not have to open folder 160-6 on the display 150 to access image representations 130-N 130-13, 130-14 and 130-15 from within that opened folder 160-6. This saves the user 108 the step of opening the folder 160-6, and then accessing image representations 130-N 130-13, 130-14 and 130-15.

In step 210, the application organizing process 140-2 renders the folder 160-N on the display 150 with a subset of a plurality of image representations 130-N associated with the folder 160-N. As shown in FIG. 10, only a subset of the image representations 130-N 130-13, 130-14 and 130-15 are rendered on the display along with folder 160-6, and those image representations 130-N 130-13, 130-14 and 130-15 may be access directly without opening folder 160-6. The remaining image representations 130-N contained within folder 160-6 can be accessed by selecting folder 160-6 to open folder 160-6 on the display 150, and then accessing those remaining image representations 130-N directly.

In step 211, the application organizing process 140-2 allows the user 108 to choose which subset of the plurality of image representations 130-N associated with the folder 160-1 is rendered on the display 150. As shown in FIG. 5 and FIG. 6, the pre-defined view chosen by the user 108 determines the number of image representations 130-N that may be rendered on the display 150 along with the folder 160-1. The user 108 may access those image representations 130-N directly by selecting them on the display 150 (i.e., without having to open the folder 160-1 to access those image representations 130-N). The application organizing process 140-2 allows the user 108 to choose which subset of image representations 130-N are rendered on the display 150 along with the folder 160-1 to allow the user 108 to determine which image representations 130-N would be most convenient to access directly.

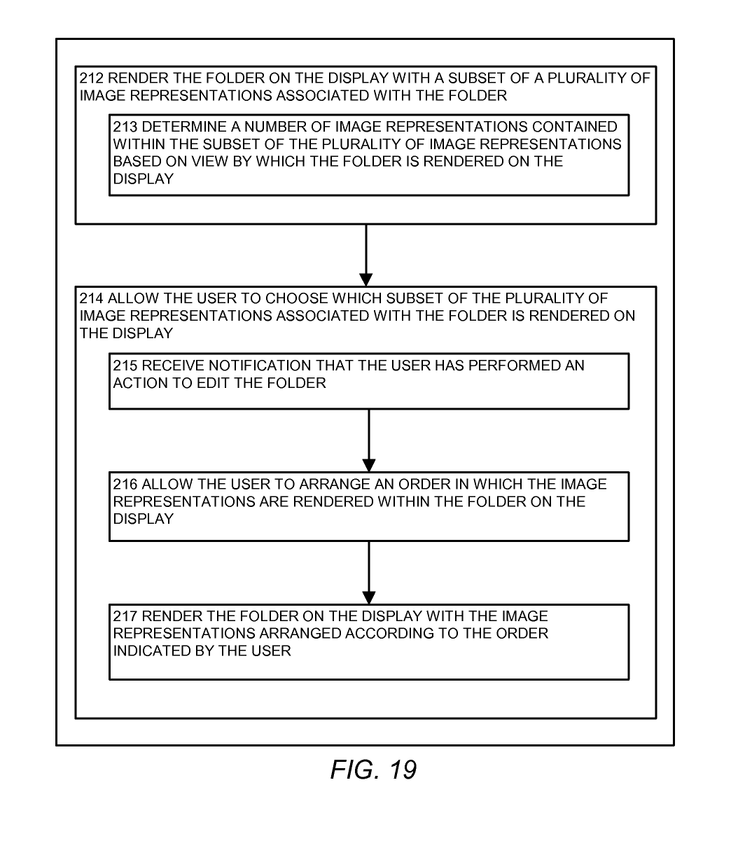

FIG. 19 is an embodiment of the steps performed by application organizing process 140-2 when it renders the folder 160-N on the display 150 with a subset of a plurality of image representations 130-N associated with the folder 160-N.

In step 212, the application organizing process 140-2 renders the folder 160-N on the display 150 with a subset of a plurality of image representations 130-N associated with the folder 160-N. As shown in FIG. 10, only a subset of the image representations 130-N 130-13, 130-14 and 130-15 are rendered on the display along with folder 160-6. The remaining image representations 130-N contained within folder 160-6 can be accessed by selecting folder 160-6 to open folder 160-6 on the display 150 and then accessing those remaining image representations 130-N directly.

In step 213, the application organizing process 140-2 determines a number of image representations 130-N contained within the subset of the plurality of image representations 130-N based on view by which the folder 160-N is rendered on the display 150. In an example embodiment, a formula is associated with the pre-defined view to determine how many of the image representations 130-N are rendered on the display 150 along with the folder 160-N. For example, FIG. 5 depicts two rows of image representations 130-N containing a total of seven image representations 130-N whereas FIG. 6 depicts one row of image representations 130-N containing three image representations 130-N. In an example embodiment, the user 108 may change these views according to the user's 108 needs.

In step 214, the application organizing process 140-2 allows the user 108 to choose which subset of the plurality of image representations 130-N associated with the folder 160-N is rendered on the display 150. The application organizing process 140-2 allows the user 108 to choose which subset of the plurality of image representations 130-N associated with the folder 160-1 is rendered on the display 150. As shown in FIG. 5 and FIG. 6, the pre-defined view chosen by the user 108 determines the number of image representations 130-N that may be rendered on the display 150 along with the folder 160-1. The user 108 may access those image representations 130-N directly by selecting them on the display 150 (i.e., without having to open the folder 160-1 to access those image representations 130-N). The application organizing process 140-2 allows the user 108 to choose which subset of image representations 130-N are rendered on the display 150 along with the folder 160-1 to allow the user 108 to determine which image representations 130-N would be most convenient to access directly.

In step 215, the application organizing process 140-2 receives notification that the user 108 has performed an action to edit the folder 160-1. In an example embodiment, the user 108 performs an action (for example, tapping the display 150) to enter into folder 160-N edit mode. The user 108 may then arrange the order of the image representations 130-N such that the most accessed image representations 130-N are available on the display 150 when the application organizing process 140-2 renders the folder 160-N on the display 150.

In step 216, the application organizing process 140-2 allows the user 108 to arrange an order in which the image representations 130-N are rendered within the folder 160-N on the display 150. In an example embodiment, the user 108 performs an action to enter into folder 160-N edit mode. The user 108 may then arrange the order of the image representations 130-N by touching the display 150 at the location of the image representations 130-N and dragging and dropping the image representations 130-N into an order of the user's 108 choosing.

In step 217, the application organizing process 140-2 renders the folder 160-N on the display 150 with the image representations 130-N arranged according to the order indicated by the user 108. When the user 108 exits folder 160-N edit mode, the application organizing process 140-2 renders the folder 160-N on the display 150 with the image representations 130-N arranged in the user's 108 chosen order. Thus, the user 108 may decide which image representations 130-N are most conveniently accessed without having to open the folder 160-N on the display 150, and may also change this arrangement of image representations 130-N at any time.

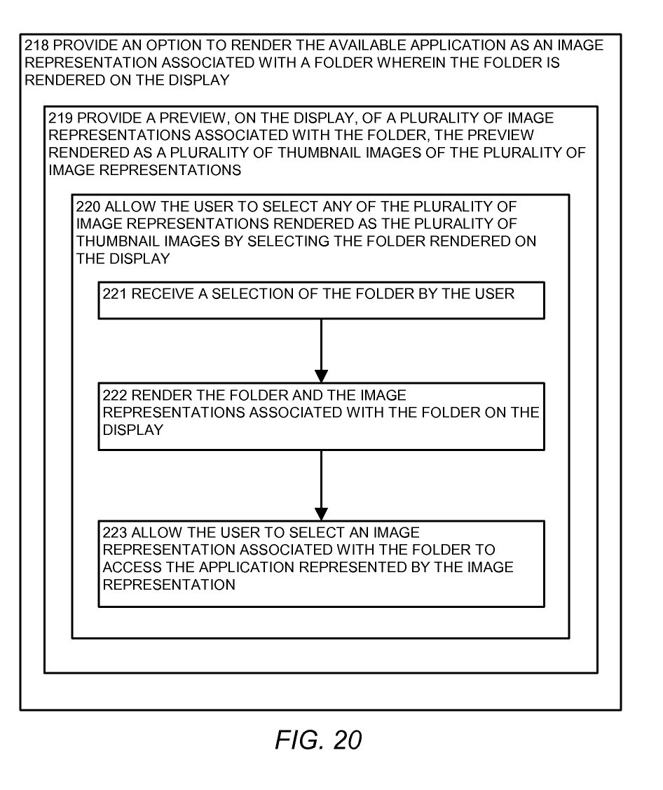

FIG. 20 is an embodiment of the steps performed by application organizing process 140-2 when it provides an option to render the available application as an image representation 130-N associated with a folder 160-N where the folder 160-N is rendered on the display 150.

In step 218, the application organizing process 140-2 provides an option to render the available application as an image representation 130-N associated with a folder 160-N where the folder 160-N is rendered on the display 150. In an example embodiment, the user 108 may arrange and organize the image representations 130-N (representing specific applications) to facilitate the user's 108 location and interaction with those applications. The application organizing process 140-2 allows the user 108 to create folders 160-N and add image representations 130-N to those folders 160-N. For example, a user 108 might create a games folder 160-6 and add various game related applications to that folder 160-6. Thus the user 108 can easily locate game related applications by accessing that folder 160-6.

In step 219, the application organizing process 140-2 provides a preview, on the display 150, of a plurality of image representations 130-N associated with the folder 160-6. The preview is rendered as a plurality of thumbnail images 180-6 images of the plurality of image representations 130-N. FIG. 10 shows an example of a preview rendered as a plurality of thumbnail images 180-6. Folder 160-6 is shown with a plurality of image representations 130-N 130-13, 130-14, and 130-15. The remaining image representations 130-N contained with folder 160-6 are represented on the display 150 by a preview of thumbnail images 180-6.

In step 220, the application organizing process 140-2 allows the user 108 to select any of the plurality of image representations 130-N rendered as the plurality of thumbnail images 180 by selecting the folder 160-6 rendered on the display 150. The user 108 may access any of the image representations 130-N in the folder 160-6 by accessing the folder 160-6 on the display 150. The application organizing process 140-2 then renders the opened folder 160-6 on the display 150, and the user 108 may select any image representation 130-N rendered on the display 150. If more image representations 130-N are contained within the folder 160-6 than can be rendered on the display 150, the user 108 may scroll through the image representations 130-N to access the remaining image representations 130-N.

In step 221, the application organizing process 140-2 receives a selection of the folder 160-4 by the user 108. FIG. 12 depicts an example restricted folder 160-4 containing shortcuts to favorite contact objects 190-21, 190-22, and 190-23. The remaining shortcuts to favorite contact objects 190-N are represented by a preview of thumbnail images 180-4. To view these remaining shortcuts to favorite contact objects 190-N, the user 108 selects the folder 160-4 on the display 150.

In step 222, the application organizing process 140-2 renders the folder 160-4 and the image representations 130-N associated with the folder 160-4 on the display 150. In response to a user's 108 selection of a folder 160-4 on the display 150, the application organizing process 140-2 renders the opened folder 160-4 on the display 150, as depicted in FIG. 13. FIG. 13 shows an opened restricted folder 160-4 containing image representations of shortcuts to favorite contact objects 190-21, 190-22, 190-23, 190-24, 190-25, and 190-26.

In step 223, the application organizing process 140-2 allows the user 108 to select an image representation 130-N associated with the folder 160-N to access the application represented by the image representation 130-N. In an example embodiment, once a user 108 opens a folder 160-4 on the display 150, the user 108 may select any of the image representations 130-N visible on the display 150. In FIG. 13, the restricted folder 160-4 contains image representations of shortcuts to favorite contact objects 190-21, 190-22, 190-23, 190-24, 190-25, and 190-26. The user 108 may select any of these shortcuts to access the respective favorite contact.

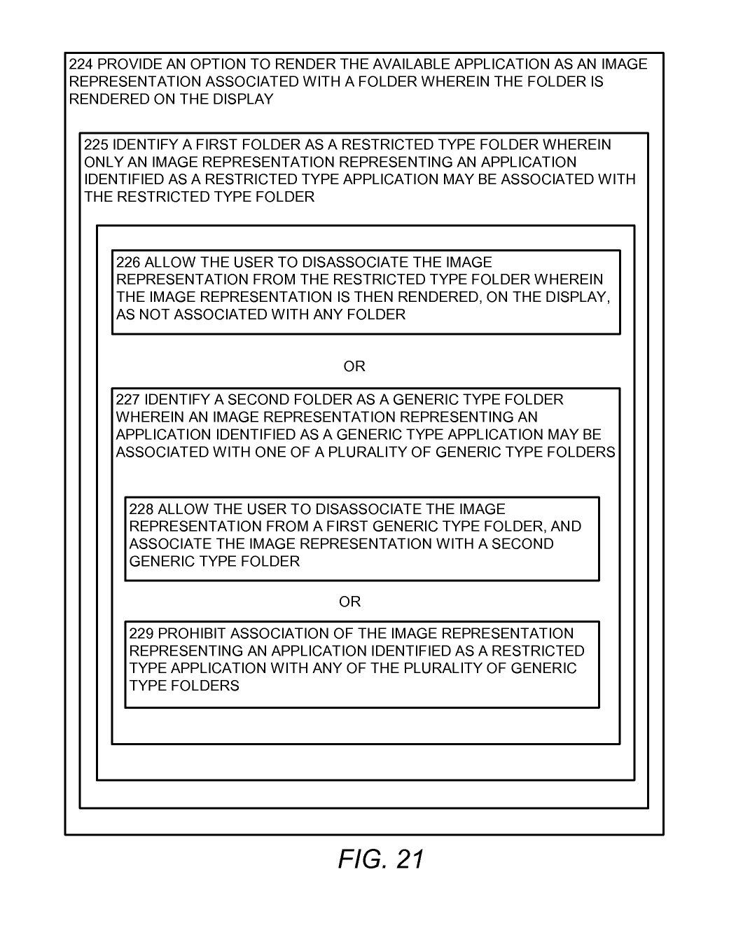

FIG. 21 is an embodiment of the steps performed by application organizing process 140-2 when it provides an option to render the available application as an image representation 130-N associated with a folder 160-N where the folder 160-N is rendered on the display 150.

In step 224, the application organizing process 140-2 provides an option to render the available application as an image representation 130-N associated with a folder 160-N where the folder 160-N is rendered on the display 150. In an example embodiment, the user 108 may arrange and organize the image representations 130-N (representing specific applications) to facilitate the user's 108 location and interaction with those applications. The application organizing process 140-2 allows the user 108 to create folders 160-N and add image representations 130-N to those folders 160-N. For example, a user 108 might create a games folder 160-6 (as shown in FIG. 10) and add various game related applications to that folder 160-6. Thus the user 108 can easily locate game related applications by accessing that folder 160-6.

In step 225, the application organizing process 140-2 identifies a first folder 160-N as a restricted type folder 160-N where only an image representation 130-N representing an application identified as a restricted type application may be associated with the restricted type folder 160-N. In an example embodiment, a user 108 may designate a folder 160-N as a restricted folder 160-N. The user 108 may then add only those image representations 130-N (representing applications that are of the same restricted type as the restricted folder 160-N) to that folder 160-N.

In step 226, the application organizing process 140-2 allows the user 108 to disassociate the image representation 130-N from the restricted type folder 160-N, and the image representation 130-N is then rendered, on the display 150, as not associated with any folder 160-N. In other words, a user 108 may add an image representation 130-N to a restricted folder 160-N as long as the image representation 130-N represents an application that is of the same restricted type as the restricted folder 160-N. If the user 108 removes that image representation 130-N from the folder 160-N, that image representation 130-N cannot go into any other restricted type folder 160-N, but may be rendered directly on the display 150.

Alternatively, in step 227, the application organizing process 140-2 identifies a second folder 160-N as a generic type folder 160-N. An image representation 130-N representing an application identified as a generic type application may be associated with one of a plurality of generic type folders 160-N. In an example embodiment, the user 108 may designate folders 160-N as generic folders 160-N. Any image representation 130-N representing an application that is a generic type application may be added to any generic type folder 160-N.

In step 228, the application organizing process 140-2 allows the user 108 to disassociate the image representation 130-N from a first generic type folder 160-N, and associate that image representation 130-N with a second generic type folder 160-N. In an example embodiment, the user 108 may remove an image representation 130-N (representing an application that is a generic type application) from a generic type folder 160-N, and may add that image representation 130-N to any other generic type folder 160-N.

Alternatively, in step 229, the application organizing process 140-2 prohibits association of the image representation 130-N representing an application identified as a restricted type application with any of the plurality of generic type folders 160-N. In an example embodiment, a image representation 130-N representing an application that is a restricted type application may not be added to a generic type folder 160-N.

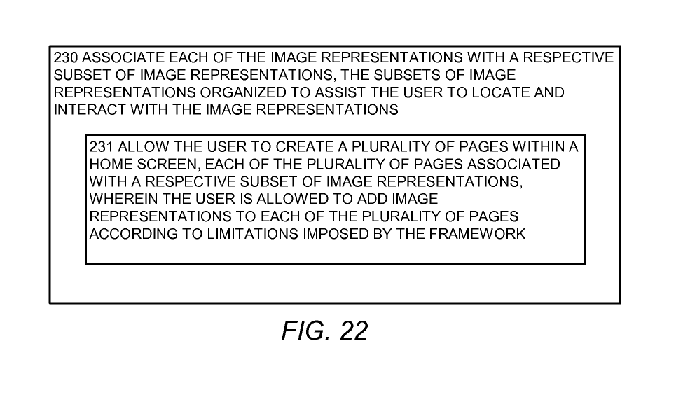

FIG. 22 is an embodiment of the steps performed by application organizing process 140-2 when it associates each of the image representations 130-N with a respective subset of image representations 130-N.

In step 230, the application organizing process 140-2 associates each of the image representations 130-N with a respective subset of image representations 130-N. The subset of image representations 130-N is organized to assist the user 108 to locate and interact with the image representations 130-N. Each subset of image representations 130-N is rendered as a page or screen on the communications device 110. A user 108 may scroll through each page (i.e., subset of image representations 130-N) by dragging a finger across the display 150.

In step 231, the application organizing process 140-2 allows the user 108 to create a plurality of pages within a home screen. Each of the plurality of pages is associated with a respective subset of image representations 130-N, and the user 108 is allowed to add image representations 130-N and folders 160-N to each of the plurality of pages according to limitations imposed by the framework. For example, a user 108 may add an image representation 130-N (representing an application) to an subset of image representations 130-N provided there is only a single instance of that application on the display 150. In an example embodiment, a user 108 may create a restricted type folder 160-N, and may add image representations 130-N representing applications that are of the same restricted type as specified by the restricted type folder 160-N.

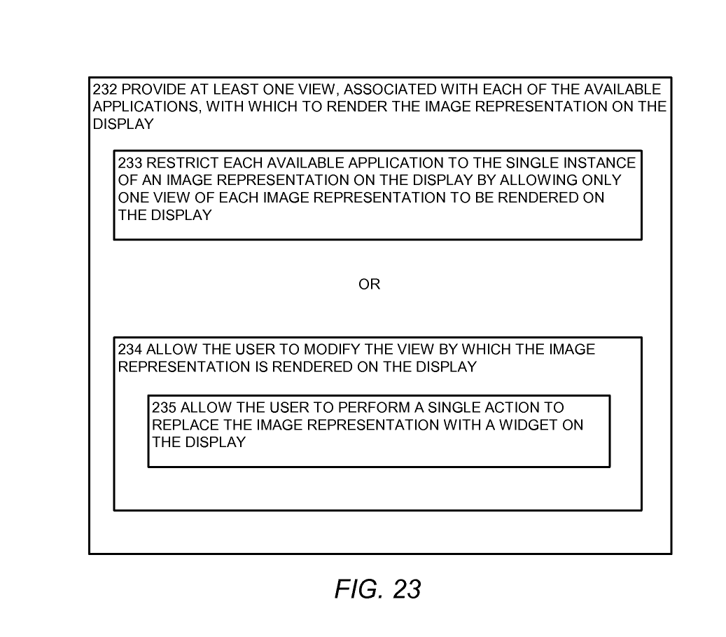

FIG. 23 is an embodiment of the steps performed by application organizing process 140-2 when it provides at least one view, associated with each of the available applications, with which to render the image representation 130-N on the display 150.

In step 232, the application organizing process 140-2 provides at least one view, associated with each of the available applications, with which to render the image representation 130-N on the display 150. Examples of different views include a music application depicted as image representation 130-8 shortcut in FIG. 7, and that same application shown as a music application widget (also image representation 130-8) depicted in FIG. 8.

In step 233, the application organizing process 140-2 restricts each available application to the single instance of an image representation 130-N on the display 150 by allowing only one view of each image representation 130-N to be rendered on the display 150. The application organizing process 140-2 assists the user 108 in maintaining organization of the applications, and locating those applications by restricting each application to a single instance of that application on the display 150.

Alternatively, in step 234, the application organizing process 140-2 allows the user 108 to modify the view by which the image representation 130-N is rendered on the display 150. FIG. 9 shows image representation 130-8 rendered as a music application widget. The application organizing process 140-2 allows the user 108 to modify the view of the image representation 130-8. The arrow 120 indicates that the user 108 has entered into an edit mode to edit the view of the image representation 130-8. In an example embodiment, the user 108 may change the view of the image representation 130-8 from a music application widget as shown in FIG. 9 to, for example, a shortcut to a music application as shown in FIG. 7 (depicted as image representation 130-8 in FIG. 7).

In step 235, the application organizing process 140-2 allows the user 108 to perform a single action to replace the image representation 130-8 with a widget on the display 150. In an example embodiment, the user 108 simply taps the display 150 once to change, for example, the music application depicted in FIG. 7 (i.e., image representations 130-8) to the widget shown in FIG. 9 (also depicted as 130-8).

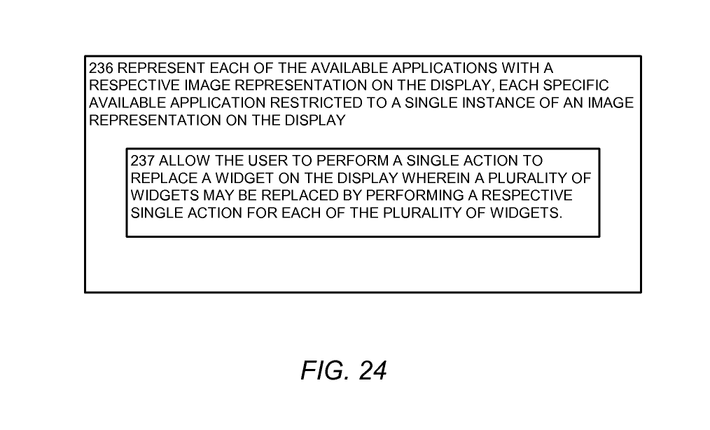

FIG. 24 is an embodiment of the steps performed by application organizing process 140-2 when it represents each of the available applications with a respective image representation 130-N on the display 150.

In step 236, the application organizing process 140-2 represents each of the available applications with a respective image representation 130-N on the display 150. The set of available applications include widgets. Widgets may be standalone applications that may be hosted by a widget system (i.e., a software service available to users for running the widgets on a graphical user interface). Widgets may be focused applications that are generally smaller in size, and less complex than typical software applications. In an example embodiment, the image representation 130-N may be an icon that the user 108 selects to access the associated application. The image representation 130-N may also be, for example, a shortcut, widget, or folder 160-N containing a plurality of image representations 130-N.

In step 237 the application organizing process 140-2 allows the user to perform a single action to replace a widget on the display 150. In an example embodiment, the user 108 performs an action (for example, tapping the display 150) to enter into edit mode. FIG. 9 depicts an example screen shot where a user 108 has entered into edit mode. Arrows (for example, arrow 120) indicate that the user 108 has entered into an edit mode to replace the image application representation 130-N with a widget in one tap, or to replace the widget with an image application representation 130-N in one tap. In an example embodiment, the user 108 may add or replace a widget on the display 150 directly, or in a folder 160-1 on the display 150. In an example embodiment, the user 108 need only tap the arrow 120 once to replace a widget. A plurality of widgets may be replaced by performing a respective single action for each of the plurality of widgets. In other words, the user 108 may replace multiple widgets by simply tapping the display 150 once for each widget replaced or added.

While computer systems and methods have been particularly shown and described above with references to configurations thereof, it will be understood by those skilled in the art that various changes in form and details may be made therein without departing from the scope disclosed herein. Accordingly, the information disclosed herein is not intended to be limited by the example configurations provided above.

What is claimed is:

1. A method of presenting an organization of available applications within a communications device, the method comprising:
providing a framework that allows a user to arrange the available applications on a display of the communications device, the framework limiting the user's arrangement to maintain consistent organization and ease of location of the available applications for the user;
representing each of the available applications with a respective image representation on the display, each specific available application restricted to a single instance of an image representation on the display;
associating each of the image representations with a respective subset of image representations, the subsets of image representations organized to assist the user to locate and interact with the image representations; and
providing at least one view, associated with each of the available applications, with which to render the image representation on the display.

2. The method of claim 1 wherein representing each of the available applications with a respective image representation on the display comprises:
providing an option to render the available application as an image representation associated with a folder wherein the folder is rendered on the display.

3. The method of claim 2 wherein providing an option to render the available application as an image representation associated with a folder comprises:
providing a plurality of pre-defined views for the folder, where each of the pre-defined views determines how the folder is rendered on the display; and
allowing the user to choose one of the plurality of pre-defined views with which to render the folder on the display.

4. The method of claim 2 wherein providing an option to render the available application as an image representation associated with a folder comprises:
rendering the folder on the display with the image representation rendered within the folder where the user may select the image representation, on the display, to access the application represented by the image representation.

5. The method of claim 4 wherein rendering the folder on the display with the image representation rendered within the folder comprises:
rendering the folder on the display with a subset of a plurality of image representations associated with the folder; and
allowing the user to choose which subset of the plurality of image representations associated with the folder is rendered on the display.

6. The method of claim 5 wherein rendering the folder on the display with a subset of a plurality of image representations associated with the folder comprises:
determining a number of image representations contained within the subset of the plurality of image representations based on view by which the folder is rendered on the display.

7. The method of claim 5 wherein allowing the user to choose which subset of the plurality of image representations associated with the folder is rendered on the display comprises:
receiving notification that the user has performed an action to edit the folder;
allowing the user to arrange an order in which the image representations are rendered within the folder on the display; and
rendering the folder on the display with the image representations arranged according to the order indicated by the user.

8. The method of claim 2 wherein providing an option to render the available application as an image representation associated with a folder comprises:
providing a preview, on the display, of a plurality of image representations associated with the folder, the preview rendered as a plurality of thumbnail images of the plurality of image representations; and
allowing the user to select any of the plurality of image representations rendered as the plurality of thumbnail images by selecting the folder rendered on the display.

9. The method of claim 8 wherein allowing the user to select any of the plurality of image representations rendered as the plurality of thumbnail images by selecting the folder rendered on the display comprises:
receiving a selection of the folder by the user;
rendering the folder and the image representations associated with the folder on the display; and
allowing the user to select an image representation associated with the folder to access the application represented by the image representation.

10. The method of claim 2 wherein providing an option to render the available application as an image representation associated with a folder comprises:
identifying a first folder as a restricted type folder wherein only an image representation representing an application identified as a restricted type application may be associated with the restricted type folder.

11. The method of claim 10 comprising:
allowing the user to disassociate the image representation from the restricted type folder wherein the image representation is then rendered, on the display, as not associated with any folder.

12. The method of claim 10 comprising:
identifying a second folder as a generic type folder wherein an image representation representing an application identified as a generic type application may be associated with one of a plurality of generic type folders; and
allowing the user to disassociate the image representation from a first generic type folder, and associate the image representation with a second generic type folder.

13. The method of claim 12 comprising:
prohibiting association of the image representation representing an application identified as a restricted type application with any of the plurality of generic type folders.

14. The method of claim 1 wherein associating each of the image representations with a respective subset of image representations comprises:
allowing the user to create a plurality of pages within a home screen, each of the plurality of pages associated with a respective subset of image representations, wherein the user is allowed to add image representations to each of the plurality of pages according to limitations imposed by the framework.

15. The method of claim 1 wherein providing at least one view, associated with each of the available applications, with which to render the image representation on the display comprises:
restricting each available application to the single instance of an image representation on the display by allowing only one view of each image representation to be rendered on the display.

16. The method of claim 1 wherein providing at least one view, associated with each of the available applications, with which to render the image representation on the display comprises:
allowing the user to modify the view by which the image representation is rendered on the display.

17. The method of claim 16 wherein allowing the user to modify the view by which the image representation is rendered on the display comprises:
allowing the user to perform a single action to replace the image representation with a widget on the display.

18. The method of claim 1 wherein representing each of the available applications with a respective image representation on the display comprises:
allowing the user to perform a single action to replace a widget on the display wherein a plurality of widgets may be replaced by performing a respective single action for each of the plurality of widgets.

19. A computerized device comprising:
a memory;
a processor;
a communications interface;
an interconnection mechanism coupling the memory, the processor and the communications interface;
wherein the memory is encoded with an application organizing application that when executed on the processor is capable of organizing applications on an interface on the computerized device by performing the operations of:
providing a framework that allows a user to arrange the available applications on a display of the communications device, the framework limiting the user's arrangement to maintain consistent organization and ease of location of the available applications for the user;
representing each of the available applications with a respective image representation on the display, each specific available application restricted to a single instance of an image representation on the display;
associating each of the image representations with a respective subset of image representations, the subsets of image representations organized to assist the user to locate and interact with the image representations; and
providing at least one view, associated with each of the available applications, with which to render the image representation on the display.

20. A computer readable medium having computer readable code thereon, the medium comprising:
instructions for providing a framework that allows a user to arrange the available applications on a display of the communications device, the framework limiting the user's arrangement to maintain consistent organization and ease of location of the available applications for the user;
instructions for representing each of the available applications with a respective image representation on the display, each specific available application restricted to a single instance of an image representation on the display;
instructions for associating each of the image representations with a respective subset of image representations, the subsets of image representations organized to assist the user to locate and interact with the image representations; and
instructions for providing at least one view, associated with each of the available applications, with which to render the image representation on the display.
